(19) United States
(12) Patent Application Publication
(10) Pub. No.: US 2016/0376690 A1
(43) Pub. Date: Dec. 29, 2016

(54) PHOSPHATING OR ANODIZING FOR IMPROVED BONDING OF THERMAL SPRAY COATING ON ENGINE CYLINDER BORES

(71) Applicant: GM Global Technology Operations LLC, Detroit, MI (US)

(72) Inventors: Yucong Wang, West Bloomfield, MI (US); Dale A. Gerard, Bloomfield Hills, MI (US)

(21) Appl. No.: 14/753,152

(22) Filed: Jun. 29, 2015

(51) Int. Cl. C23C 4/02; F02F 1/00; F02F 7/00; C23C 4/06

(52) U.S. Cl. CPC C23C 4/02; C23C 4/06; F02F 1/004; F02F 7/0021

(57) ABSTRACT

An engine cylinder bore with an anodized or phosphated bondcoat and a method of coating the surface of an engine cylinder bore with an anodized or phosphated bondcoat prior to depositing a thermally sprayed protective coating. Cleaning or related pretreatment operations may also be used. In one preferred form, the cylinder bore is made from an aluminum-based alloy or a magnesium-based alloy, while the bondcoat forms a porous interface between the cylinder bore and the outermost protective coating. Additives may be placed into the anodizing or phosphating solution to promote adhesion and corrosion resistance.

### BACKGROUND OF THE INVENTION

This invention is related generally to achieving better adhesion between a thermal sprayed protective coating and an underlying substrate, and in particular to the use of phosphating or anodizing on the surface of an engine cylinder bore to improve adhesion between it and the thermal sprayed coating such that a separate liner is not required to protect the bore during engine operation.

The cylinder walls of an internal combustion engine (ICE) are manufactured to exacting standards with close tolerances between them and the engine's reciprocating piston as a way to promote efficient engine operation. The attainment of more power from higher revving speeds and hotter, more complete combustion processes places additional loads on engines in ways that can negatively impact their durability, especially in engine configurations that employ lighter-weight materials that exhibit different performance characteristics than their iron-based counterparts. Nowhere are these issues of more concern than in the increased thermal and friction loads imparted to the cylinder walls of the engine block that—along with the pistons and spark mechanisms—make up the combustion chamber of these advanced engine designs.

A conventional way to provide protection for cylinder bores made from lightweight engine alloys is to use a separate cylinder sleeve (also referred to as a liner). In a conventional form, the sleeve is made from an iron-based material, and while such sleeves are useful for their intended purpose, they add significant weight to an engine. Moreover, by being separate components designed to fit within the aforementioned exacting dimensions of the cylinder bore, they too require precise manufacture to ensure secure, durable placement that undesirably adds to the complexity and concomitant costs.

Thermal spray techniques have been shown to be a way to deposit protective coatings—such as thermal barrier coatings, wear and scuffing resistant coatings, anti-corrosion coatings, lubricant retention coatings or the like—onto a workpiece. The high deposition rates make such coating approaches amenable to large-scale manufacturing, and include as examples plasma transferred wire arc (PTWA), rotating single wire (RSW), high velocity oxygen fuel (HVOF), powder plasma and twin wire arc (TWA). The present inventors have previously investigated ways to use thermal spray coatings as a way to obviate cylinder sleeves for engine block cylinder bores, but have found that such coatings may suffer from durability issues related to the inability of the coating to adhere to the bore wall.

Adhesion of a thermal spray protective coating to a substrate is a very important metric for determining the suitability of the coating for a particular application. Traditionally, improvements in coating adhesion to the substrate were achieved through various surface activation pretreatment steps, including approaches such as grit blasting with ceramic particles, high-pressure water jet blasting and mechanical roughening or related dovetailing or locking. While effective for their intended purpose, they add complexity and cost to the coated component's manufacturing process. For example, mechanical roughening/locking-based approaches involve high tooling costs (due at least in part to short tool life) and extensive cleanup requirements. Likewise, the high-pressure water jet blasting approach has very high capital costs, while the grit blasting approach has sand contamination problems, as well as (along with the mechanical roughening mentioned above) significant cleanup requirements. Some of these cleanup requirements (as well as substrate pretreatment) may also use volatile organic compounds (VOCs) the use of which is coming under increasing scrutiny for their potentially negative environmental impact.

As such, there remains a need for an alternative to these known approaches for adhering protective coatings to substrates in general, and to the walls of engine cylinder bores in particular. Likewise, there may be circumstances where one of the aforementioned surface activation pretreatment steps may be necessary; in such case, there remains a need for effectively and easily removing any remnants or related contaminants that arise out of the use of such pretreatment. Furthermore, there remains a need for applying a porous coating to improve the bonding of a subsequently-applied thermal spray coating, regardless of whether or not the conventional grit blasting, water jet blasting or mechanical roughening are employed.

### SUMMARY OF THE INVENTION

According to an aspect of the present invention, a method of coating the surface of an aluminum-based engine cylinder bore substrate includes cleaning the surface in order to substantially remove one or more contaminants, activating the surface by either anodizing or phosphating and then forming a thermal spray coating on the activated surface. As such, the use of phosphating or anodizing improves the bonding of a subsequently-applied thermal spray coating to the cylinder bore surface. In one preferred form, the present approach acts as a replacement for the aforementioned grit blasting, high-pressure water jet, or mechanical roughening, while in another, it can be used as an additional process to these techniques to further increase the coating bonding adhesion.

According to another aspect of the present invention, a method of preparing the surface of an engine cylinder bore for subsequent thermal spray coating includes cleaning the surface in order to substantially remove a contaminant therefrom; and activating the surface by either anodizing or phosphating.

According to yet another aspect of the present invention, an internal combustion engine component made up of an engine block that defines numerous cylinder bores therein is disclosed. A bondcoat is formed onto a surface defined by the cylinder bores, the bondcoat formed by the group consisting of phosphating or anodizing; and a thermal spray coating deposited on the bondcoat. In one preferred form, the cylinder bores are made of an aluminum-based material, while the bondcoat is made from an oxide of aluminum and the thermal spray coating is made from an iron alloy.

### BRIEF DESCRIPTION OF THE DRAWINGS

The following detailed description of the preferred embodiments of the present invention can be best understood when read in conjunction with the following drawings, where like structure is indicated with like reference numerals and in which the various components of the drawings are not necessarily illustrated to scale:

FIG. 1 depicts a view of a notional engine block with four cylinder bores formed therein that could receive surface activation and a thermal spray coating according to an aspect of the present invention;

FIG. 2 depicts a notional surface of a cylinder bore of the engine of FIG. 1 that has been subjected to mechanical roughening pretreatment;

FIG. 3 depicts a notional surface of a cylinder bore of the engine of FIG. 1 that has been subjected to high pressure water jet pretreatment;

FIG. 4 depicts a notional surface of a cylinder bore of the engine of FIG. 1 that has been subjected to grit blasting pretreatment;

FIG. 5 shows a cutaway view of the engine cylinder bore of the engine block of FIG. 1 with the deposition of a protective coating via thermal spray device according to an aspect of the present invention; and

FIG. 6 shows a cutaway view of the cooperation between a piston, the wall of an engine cylinder bore and a protective coating that is deposited according to an aspect of the present invention.

### DETAILED DESCRIPTION OF THE PREFERRED EMBODIMENT

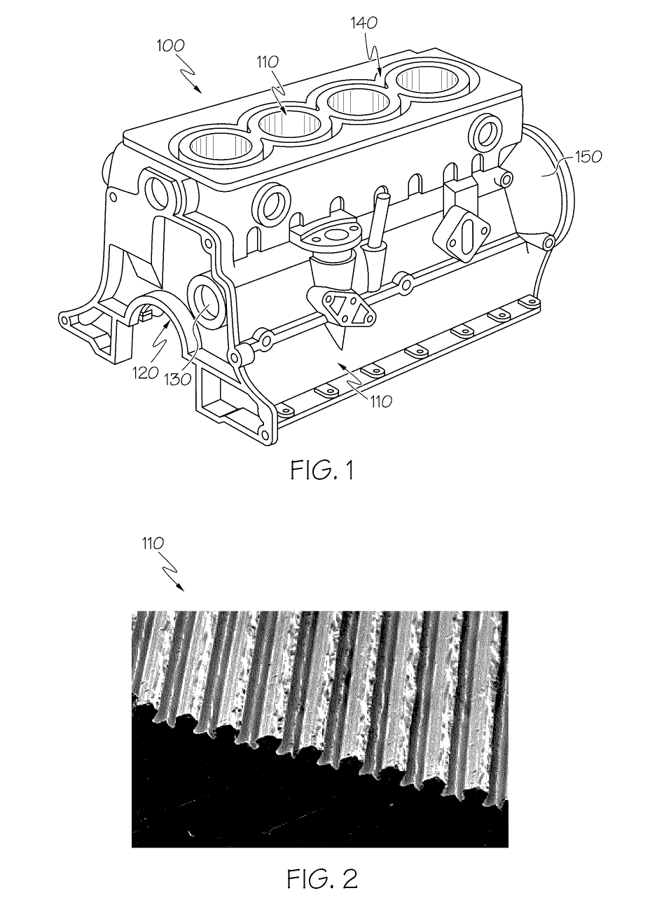

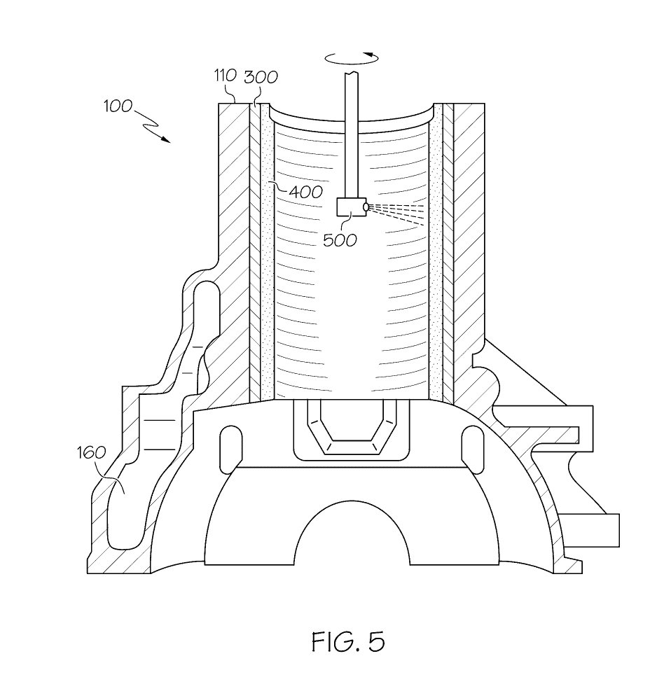

Referring first to FIG. 1, a simplified view of a four-cylinder automotive internal combustion engine block 100 with cylinder bores (also referred to herein as “engine bores” or more simply, “bores”) 110 is shown. In addition to the bore 110, and depending on the engine configuration, the block 100 includes portions for—among other things—the crankcase and its bearings 120, camshaft bearings (none of which are presently shown), power takeoff connectors 130, water cooling jackets 140, transmission mounting hardware 150 and coolant or lubricant flowpaths 160 (as shown with particularity in FIG. 5). As mentioned above, traditionally, these bores 110 have included a separate heavy cast iron insert or sleeve (typically about 2 to 3 mm in thickness) that is sized to fit securely within. In fact, in engine configurations where the block 100 is cast from a lightweight material, such as aluminum and its alloys (such as A380, A319 or A356) or magnesium or its alloys, the addition of such liners was traditionally deemed to be necessary as a way to impart wear resistance. The present inventors have determined that when block 100 is cast from a traditionally hard-to-cast alloy, such as from the Al/Cu class of alloys, hypereutectic alloys (such as 390) or the like, the application of thermal spray coatings after the pretreatment made possible by the anodizing or phosphating according to one or more aspects of the present invention enables bore 110 protection without the need for such liners. In fact, while traditional hypoeutectic alloys (such as 319 and 356) that the Assignee of the present disclosure currently uses for engine blocks, as well as near-eutectic or eutectic alloys (such as 380) may be beneficially used with the methods disclosed herein, the present inventors are of the belief that such “bare-bore” configurations (i.e., where no separate iron-based cylinder liners or other inserts would be needed) is especially likely when the treatment processes discussed herein are used in conjunction with the aforementioned hypereutectics, Al/Cu and related hard-to-cast alloys.

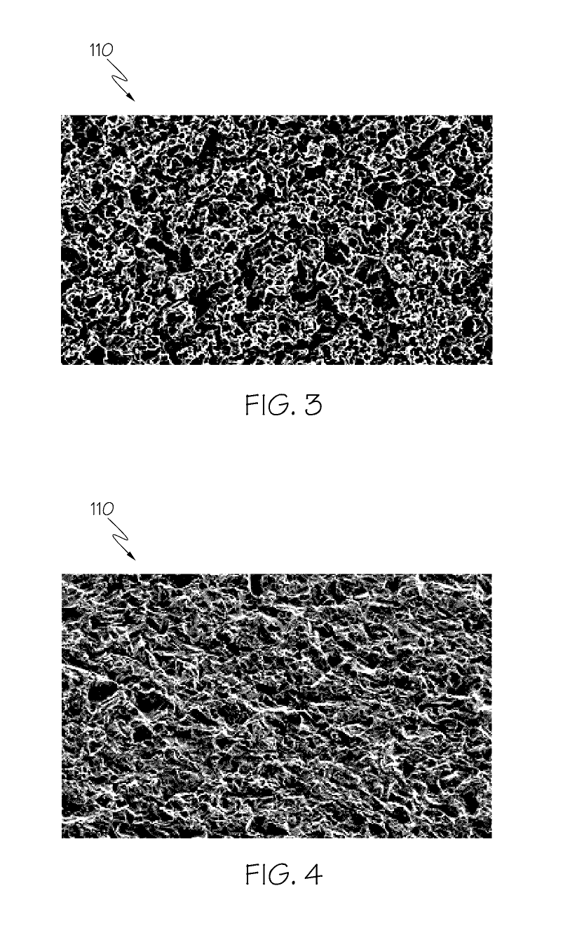

Referring next to FIGS. 2, 3 and 4, micrographs depicting cylinder bore 110 surfaces that have been treated by mechanical roughening with locking undercut geometric shapes (FIG. 2), high-pressure water jetting (FIG. 3) and grit blasting (FIG. 4) are shown. As can be seen, such roughening changes the topography on the cylinder bore 110 surface to promote an interlocking fit between the coating and the substrate. With particular regard to FIGS. 2 and 3, the surface defines a roughness that tends to generally mimic the porosity produced by the phosphating or anodizing bondcoats (referred to generally as 300 and more particularly as 300A for the phosphated version and 300B for the anodized version) that are discussed in more detail below. Without being bound to theory, the present inventors are of the belief that the roughness and related surface porosity are integral to achieving the high level of bonding between both the cylinder bore 110 and the bondcoat 300, as well as between the bondcoat 300 and thermal spray coating 400.

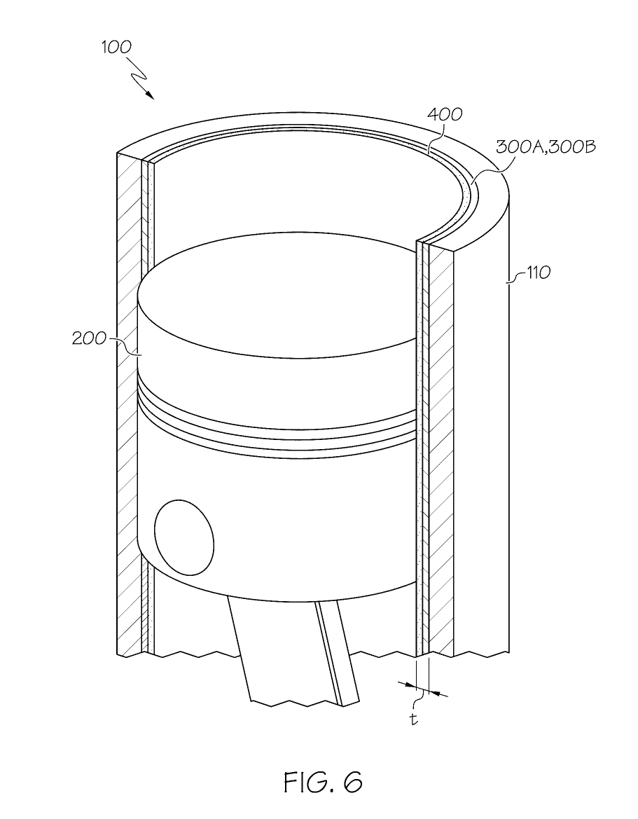

Referring next to FIGS. 5 and 6, spray-based applications may be used to deposit both the bondcoat 300 and the thermal spray coating 400 onto the substrate that is in the form of an inner wall that is defined by the cylinder bore 110. In the present context, reference to the substrate, surface, inner wall, circumferential surface or like terms shall be construed to include the inner wall of the cast cylinder block 100 that by the present coating may eschew a separate cylindrical-shaped sleeve, insert or related liner configured to fit within the bore 110. In one form, the current proposed method of applying the bondcoat 300 as depicted in the figures can be a replacement of any of the above mentioned processes (grit blasting, high-pressure water jet, or mechanical roughening), while in another form it can be used as an add-on process to further increase the coating bonding adhesion. In one preferred form, the combined thickness t of the anodized or phosphated bondcoat 300 in conjunction with the thermal spray coating 400 made according to an aspect of the present invention is no more than about 300 μm thick, and therefore significantly lighter in weight than the insertable liners of the known art.

In one exemplary form, the thermal spray coating 400 is in the form of an iron-based wear coating, while the spray-based technique used in its deposition may be through a carbon steel alloy wire. The device used to apply the bondcoat 300 is preferably in the form of a spray gun 500. A stem (which may be made to rotate) in the form of a pressurized axial fluid conduit 510 may be used as a secure mounting platform for gun 500. Details of the cooperation between the rotating axial fluid conduit 510 and its use in cylinder bore 110 may be found in co-pending U.S. application Ser. No. 14/335,974 entitled NON-DESTRUCTIVE ADHESION TESTING OF COATING TO ENGINE CYLINDER BORE that is owned by the Assignee of the present invention and incorporated herein by reference in its entirety. In one preferred form, the wall of cylinder bore 110 that has been treated with the bondcoat 300 and thermal spray coating 400 has a total protective coating of approximately 100 to 200 μm thick, with about 5 to 15 μm due to the bondcoat 300 regardless of whether the formation is by phosphating or anodizing. Moreover, the adhesion achieved by the application of the bondcoat 300 according to an aspect of the present invention is at least about 40 MPa or more. Furthermore, although the spray-based approach depicted in FIG. 5 is shown within the phosphating context, it can be used for anodizing with a suitable substitution of the sprayable material chemical solutions.

Phosphating

Suitable phosphate coatings that can be used in conjunction with FIGS. 5 and 6 include zinc phosphate, iron phosphate and manganese phosphate. The phosphate process also involves some pre- and post-phosphating activities, including cleaning the bore 110, spray or immersion rinsing after the cleaning, rinsing again after the phosphating, and chromic acid rinsing following post-phosphate rinse. Once applied, these phosphate bondcoats 300A are used as a foundation for subsequent coatings (such as the aforementioned thermal spray coatings 400). A preferred precursor involves the use of a dilute solution of phosphoric acid and phosphate salts to chemically react with the cylinder bore 110 to form a bondcoat 300A layer of insoluble, crystalline phosphates (also called phosphate conversion coatings). In a preferred form, the resulting phosphate coatings are based on manganese, iron and zinc. Of these, manganese-based phosphates are applied only by immersion, while iron-based and zinc-based phosphates are applied by either immersion or spraying. Of the three, iron-based and zinc-based phosphates are preferable as a foundational coating than manganese-based phosphates. Although spray gun 500 is shown as a single device in FIG. 5 for simplicity, in actuality two separate spraying devices are typically employed, as the system requirements and spraying dynamics of iron-based protective coating 400 and the phosphate-based bondcoat 300 differ from one another.

The application of phosphate coatings makes use of phosphoric acid and takes advantage of the low solubility of phosphates in medium or high pH solutions. Iron, zinc or manganese phosphate salts are dissolved in a solution of phosphoric acid. When parts are placed in the phosphoric acid, an acid and metal reaction takes place which locally depletes the hydronium (H₃O⁺) ions, raising the pH, and causing the dissolved salt to fall out of solution and be precipitated on the surface of the engine bore 110. The acid and metal reaction also generates hydrogen gas in the form of tiny bubbles that adhere to the surface of the metal, thereby preventing the acid from reaching the metal surface; this too slows down the reaction. To overcome this, sodium nitrite is added in the solution to act as an oxidizing agent that reacts with the hydrogen to form water. This in turn prevents hydrogen from forming a passivating layer on the surface. The preferred steps in preparing a surface through phosphating (as well as through anodizing, discussed in more detail below) that is to be treated with a subsequently-applied thermal spray coating includes (1) cleaning the surface (for example, the cylinder bore surface), (2) rinsing, (3) surface activation, (4) phosphating, (5) rinsing, (6) optional neutralizing rinse, and (7) drying, after which the thermal sprayed coating is applied.

Furthermore, although either immersion-based or spray-based techniques can be used for either phosphating or anodizing, the present inventors have found that the spray-based method is especially preferred for treating the specific environment associated with engine cylinder bores. In particular, the spray process requires much shorter time for each cylinder bore treatment due to strong chemical reaction through kinetics. Nevertheless, the ability to treat multiple cylinder bores at the same time as part of a batch process (as well as lower long-term capital investment) may make the immersion-based approach preferable in certain circumstances.

The performance of the phosphate-based bondcoat 300A is significantly dependent on the crystal structure, as well as the coating thickness. For example, a coarse grain structure may be the most desirable for adhesion of the subsequent thermal spray coating 400. This coarseness may be controlled by selecting the appropriate phosphate solution, using various additives, and controlling bath temperature, concentration, and phosphating time. For surface activation, an additive may be placed in the rinse bath preceding the phosphating to seed the surface with tiny particles of a metal (preferably titanium) salt.

As an example, an aluminum cylinder bore surface is processed with spraying by a zinc phosphating solution containing a fluoride with a concentration of 200 to 600 mg/l on a basis converted into the HF concentration. If the fluoride concentration is less than 200 mg/l, the active fluorine concentration becomes too low, which makes it hard to establish a uniform zinc phosphate coating film onto an aluminum-based metal surface. Contrarily, if it is too high, precipitation of an aluminum ion becomes too large, which in turn deleteriously causes a precipitate to form in the phosphating bath. The fluoride may be in the form of HF, NaF, KF, NH₄F, NaHF₂, KHF₂, and NH₄NF₂, and related compounds.

With particular regard to the zinc phosphates mentioned above, the phosphating solution may also contain Na₃AlF₆, H₂SiF₆, HBF₄ or related fluorinated compounds as a way to adjust the active fluorine concentration within the solution. As part of controlling the active fluorine concentration, a value indicated by a silicon electrode meter can be used as a standard, where the silicon electrode meter has a high sensitivity in an acidic region of the pH range, as well as a characteristic property with which a value indicated becomes large in proportion to the active fluorine concentration. It is preferred that a value so indicated is in a range of 15 to 130 μA, with a more preferable range between 40 and 110 μA. The present inventors have determined that if the indicated value is less than 15 μA, the active fluorine concentration is too low such that a non-uniform bondcoat 300A is formed. Likewise, if the indicated value exceeds 130 μA, the active fluorine concentration is too high, which leads to precipitation problems.

Moreover, the present inventors have determined that if the zinc ion concentration is less than 0.1 g/l, it is difficult to form a uniform zinc phosphate version of bondcoat 300A on the metal surface of the engine bore 110. Conversely, if the zinc ion concentration exceeds 2.0 g/l, a uniform zinc phosphate coating film is formed, but the coating film is easily dissolved in an alkali (especially under an alkali atmosphere). Furthermore, if the phosphate ion concentration is less than 5 g/l, a non-uniform coating film is apt to be formed, and if it exceeds 40 g/l, more balancing compounds are needed; while such compounds generally don't alter the performance of the bondcoat 300, their inclusion will increase the cost of the phosphating solution.

The phosphating solution may also contain NaOH. The free acid (FA) is defined by a milliliter (ml) amount of a 0.1 N—NaOH solution consumed to neutralize 10 ml of the phosphating solution using bromophenolblue as an indicator. If the FA is less than 0.5, a uniform zinc phosphate coating film is not formed on an aluminum-based surface such as engine bore 110 and, if it exceeds 2.0, a zinc phosphate coating film containing the Na₃AlF₆ component is formed on an aluminum-based surface and the corrosion-resistance sometimes lowers.

The phosphating solution may optionally contain one or both of manganese and nickel ions. Preferably, the manganese ion (preferably in the form of Mn⁺²) is present in a concentration of about 0.1 g/l to about 3 g/l, and more preferably between about 0.6 g/l and about 3 g/l. Concentrations lower than these makes it harder to adhere the zinc that is in the solution to the engine bore 110, while concentrations in excess of 3 g/l tend to lower the corrosion resistance. Likewise, preferable ranges for the nickel ion (in the form of Ni⁺²) is between about 0.1 g/l to about 4 g/l, and more preferably between about 0.1 g/l and about 2 g/l; outside of those ranges, the corrosion resistance decreases. Without being bound by theory, the present inventors are of the belief that the presence of Ni⁺² ions in the phosphating bath improves the corrosion resistance at the base of pores, in addition to accelerating the surface reactions during the phosphating. Similarly, the addition of Mn⁺² ions to the bath improves the corrosion resistance and decreases the porosity by formation of a dense and fine microstructure.

In one exemplary phosphating process, the cylinder surface of the engine bore 110 is at first processed for degreasing with at least one of spraying and dipping at a temperature of 20° to 60° C. for 2 minutes using an alkaline degreasing agent. After that, it is rinsed with tap water. The engine bore 110 is then placed in the path of a spraying mechanism (such as the spray gun 500 of FIG. 5) such that a zinc phosphating solution is sprayed onto the engine bore 110 (that is at a temperature of 20° to 70° C.) to form the bondcoat 300A thereon; preferably, this spraying is performed for longer than 15 seconds, and more preferably for about 30 to 120 seconds, after which it is rinsed with one or both of tap water and deionized water.

Anodizing

In the present context, anodizing is an electrolytic passivation process used to increase the thickness of the natural oxide layer that forms on the surface of the part to be treated (specifically, the cylinder bore 110); as such, it is the call of the bore 110 that forms the anode of an electrical circuit. The superior adhesion from anodizing for the subsequent thermal spray coating 400 is due in part to the cleanliness and porosity of the resulting anodic films. In situations where the cylinder bore 110 is made from an aluminum-based material, the formed layer or coating is predominantly (if not substantially entirely) made of aluminum oxide (Al₂O₃) when oxidized under neutral or alkaline microelectrolytic conditions. Anodizing changes the microscopic texture of the surface and the crystal structure of the cylinder bore 110 near the surface, typically producing a much stronger, more adherent layer than the subsequently-applied thermal spray coating 400. Significantly, the porous nature of the anodized bondcoat 300B defines a roughened topography that promotes an interlocking fit between it and thermal spray coating 400. The present inventors are of the belief that the increased surface texture that the porosity provides is indicative of significant chemical bonding (and attendant adhesion) taking place on the cylinder bore 110. Thus, while it is generally undesirable to leave an exposed (i.e., outermost) layer with an inordinately high degree of porosity, it is desirable for such surface porosity to be present in the bondcoat 300B as long as a layer of thermal spray coating 400 is subsequently-applied. Within the present context, the inventors are of the belief that the surface pores of the bondcoat 300B should preferably be up to, but no more than, about 10 to 100 microns in diameter. In one form, the porosity of the anodized bondcoat 300B is such that it provides adequate adhesion to the subsequent thermal spray coating.

The anodized bondcoat 300B is grown by passing a direct current through an electrolytic solution, with the engine bore 110 serving as the anode (i.e., the positive electrode). The current releases hydrogen at the cathode and oxygen at the surface of the engine bore 110, creating a build-up of Al₂O₃. Alternating current or pulsed current may also be used in place of the direct current. The voltage required by various solutions may range from 1 to 300 V DC, typically in the range of 15 to 21 V. Higher voltages are typically required for thicker coatings formed in sulfuric acid. The anodizing current varies with the area of aluminum being anodized, and typically ranges from 30 to 300 A/m². Aluminum anodizing is usually performed in an acid solution which slowly dissolves the Al₂O₃. The acid action is balanced with the oxidation rate to form pores in the bondcoat 300B. Significantly, these pores permit the electrolyte solution and current to reach the aluminum substrate of the engine bore 110 as a way to continue growing the bondcoat 300B until it reaches its desired thickness.

Conditions such as electrolyte concentration, acidity, solution temperature and current must be controlled to allow the formation of a consistent oxide layer in the bondcoat 300B. Harder, thicker films tend to be produced by more dilute solutions at lower temperatures with higher voltages and currents. Within the present context, the thickness of the bondcoat 300B can be made to range from about 1 μm up to over 100 μm. For example, a bondcoat 300B may have between about 5 μm and 15 μm in thickness. In another form (not shown), bondcoat 300B may be even thinner, on the order of about 3 μm. In one preferred embodiment, a preferable range of total thickness of the bondcoat 300B may be between about 3 μm and about 50 μm, while that of the subsequently-applied thermal spray coating 400 is at least 100 μm. As with the porosity and coating thickness, roughness and hardness are preferably controlled to match the needs of the piston 200, engine bore 110 combination.

In one exemplary anodizing process, the engine bore 110 surface is typically pretreated, although in some situations a pretreatment is optional. Such pretreatment includes cleaning the surface by water and spraying it with 10% by weight NaOH aqueous solution at 50° C. for about two minutes. The surface is then rinsed one or more times in water, after which it is then chemically polished by spray with a solution containing 60% by volume of nitric acid and 20% by volume of hydrofluoric acid at 40° C. for 0.5 to 2 minutes, followed by rinsing in water for two minutes. The anodizing follows, and may be performed by either immersion or spray. Details associated with an electroplating version of the immersion-based approach may be found in co-pending U.S. patent application Ser. No. 14/733,121 that was filed on Jun. 8, 2015 and entitled TIO₂ APPLICATION AS BONDCOAT FOR CYLINDER BORE THERMAL SPRAY that is owned by the Assignee of the present invention and incorporated by reference in its entirety into the present disclosure. It will be understood by those skilled in the art that electroplating, phosphating and anodizing are generally similar chemical processes, and that while each has their own particular needs, there is significant overlap in the type of equipment used, most of which is depicted in the '121 application. For purposes of illustration and not limitation, more particular exemplary forms of several anodizing processes and electrolytes which are suitable for anodizing aluminum alloy substrates are described below.

In a first electrolyte, an aqueous sulfuric acid solution where sulfuric acid is present in an amount of 100 to 200 g/L of the solution is maintained at a temperature between about 10° C. and 15° C., while the current density is preferably between about 1 and 3 A/dm² for a duration of about 1 to 60 minutes.

In a second electrolyte, an aqueous oxalic acid solution where the oxalic acid is present in an amount of 400 to 100 g/L of the solution is used. The electrolyte temperature is maintained between about 15° C. and 25° C., where an applied current density is between about 2 A/dm² and 3.5 A/dm² for a duration of about 1 to 60 minutes.

In a third electrolyte, an aqueous mixture of sulfuric acid, oxalic acid, and tartaric acid solution is used, where the sulfuric acid is present in an amount of 175 to 205 g/L of the solution, the oxalic acid is present in an amount of 10 to 20 g/L of the solution, and the tartaric acid is present in an amount of 10 to 20 g/L of the solution. The electrolyte temperature is preferably maintained between 10° C. and 20° C., while the applied current density is between about 1 and 3 A/dm². The duration is (as above) between 1 and 60 minutes.

In a fourth electrolyte, an aqueous chromic acid solution—where the chromic acid is present in an amount of 40 to 50 g/L of the solution—is used. The electrolyte temperature is preferably maintained between about 30 and 35 degrees C., while the applied current density is between about 1 and 4 A/dm² for a duration of 1 to 60 minutes.

In the case of Al₂O₃, the oxide of the anodized bondcoat 300B has a much lower thermal conductivity and coefficient of linear expansion than the underlying aluminum from which it formed. As a result, the bondcoat 300B has a tendency to crack from thermal stress if exposed to temperatures above 80° C.; however, such cracking advantageously does not lead to peeling. Moreover, the extremely high melting point of Al₂O₃ is 2050° C., which is significantly higher than that of pure aluminum at 658° C. The nature of the aluminum anodizing process is such that the Al₂O₃ is grown down into as well as out from the surface of the engine bore 110 by equal amounts. In particular, because anodizing is a chemical conversion process where the resulting oxide defines a much larger volume than the precursor aluminum, about of the converted oxide extends outward from the surface, while the other half extends inward to the original surface. As such, anodizing will increase the part dimensions on each surface by half the oxide thickness. By comparison, while phosphating (discussed above) is also a chemical conversion process, the nature of its formation is such that it is almost exclusively an outwardly-extending buildup from the surface.

The present inventors have determined that three types of anodizing are particularly useful to produce bondcoat 300B, including chromic acid anodizing and two types of sulfuric acid anodizing. With chromic acid anodizing, the chromic acid produce thinner (0.5 μm to 18 μm) more opaque films that are softer and ductile. The method of film formation is different from using sulfuric acid in that the voltage is ramped up through the process cycle when chromic acid is used. With a first type of sulfuric acid anodizing, bondcoats 300B of moderate thickness (2 μm to 25 μm) may be produced (these are often referred to as Type II coating in North America), while the second type of sulfuric acid anodizing produces bondcoat 300B thicker than 25 μm (which are known as Type III coatings), Of these, thicker coatings require more process control, and are preferably produced in a refrigerated tank near the freezing point of water with higher voltages than the thinner coatings. The present inventors have also determined that anodizing can also be carried out using phosphoric acid. Likewise, plasma electrolytic oxidation may be used along with higher voltage levels, where the sparking results in more crystalline/ceramic type coatings (should such coatings be desired).

It is noted that terms like “preferably”, “generally” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention, it is noted that the terms “substantially” and “approximately” and their variants are utilized herein to represent the inherent degree of uncertainty that may be attributed to any quantitative comparison, value, measurement or other representation. The term “substantially” is also utilized herein to represent the degree by which a quantitative representation may vary from a stated reference without resulting in a change in the basic function of the subject matter at issue.

Having described the invention in detail and by reference to specific embodiments, it will nonetheless be apparent that modifications and variations are possible without departing from the scope of the invention defined in the appended claims. In particular it is contemplated that the scope of the present invention is not necessarily limited to stated preferred aspects and exemplified embodiments, but should be governed by the appended claims.

We claim:

1. A method of coating the surface of an engine cylinder bore, said method comprising:
cleaning said surface in order to substantially remove a contaminant therefrom;
activating said surface by either anodizing or phosphating; and
forming a thermal spray coating on said activated surface.

2. The method of claim 1, wherein said contaminants are produced by a pretreatment selected from the group consisting essentially of grit blasting, high-pressure water jet, laser etching or mechanical roughening such that said cleaning takes place after said pretreatment.

3. The method of claim 1, wherein said activating is performed instead of a pretreatment selected from the group consisting essentially of grit blasting, high-pressure water jet, laser etching or mechanical roughening.

4. The method of claim 1, wherein said phosphating or anodizing forms a porous coating layer as a bondcoat.

5. The method of claim 4, wherein said bondcoat comprises a ceramic oxide.

6. The method of claim 5, wherein said ceramic oxide comprises alumina.

7. The method of claim 4, wherein said porous coating defines a porosity of less than about 0.5 millimeters in diameter.

8. The method of claim 1, wherein a material making up said cylinder bore is selected from the group consisting of an aluminum-based material, a magnesium-based material and combinations thereof.

9. The method of claim 1, wherein said activating is performed by a spray-based method.

10. The method of claim 1, wherein said activating is performed by an immersion-based method.

11. The method of claim 1, wherein said phosphating comprises spraying said surface with a zinc phosphating solution containing a fluoride with a concentration of between about 200 to 600 mg/l.

12. The method of claim 11, wherein said phosphating solution further contains at least one of a manganese ion in a concentration of between about 0.1 g/l and 3 g/l, and a nickel ion in concentration of between about 0.1 g/l and 4 g/l.

13. The method of claim 1, wherein said forming a thermal spray coating comprises depositing at least one layer of an iron-based material.

14. A method of preparing the surface of an engine cylinder bore for subsequent thermal spray coating, said method comprising:
cleaning said surface in order to substantially remove a contaminant therefrom; and
activating said surface by either anodizing or phosphating.

15. The method of claim 14, wherein said phosphating comprises spraying a solution containing at least one of zinc phosphate and iron phosphate, as well as at least one of a fluoride, fluoride adjustment compound, manganese-bearing ion and nickel-bearing ion.

16. The method of claim 14, wherein said cleaning comprises:
spraying said surface with a liquid;
rinsing said surface at least one time in water;
chemically polishing said surface with an acid-based solution; and
rinsing in water.

17. The method of claim 16, wherein said activating is performed by a spray-based method.

18. The method of claim 16, wherein said activating is performed by an immersion-based method.

19. The method of claim 18, wherein said surface is aluminum-based such that an electrolyte used in said activation is selected from the group consisting essentially of an aqueous chromic acid solution, a sulfuric acid solution, an aqueous oxalic acid solution, an aqueous tartaric acid solution and combinations thereof.

20. An internal combustion engine component comprising:
a block defining a plurality of cylinder bores therein;
a bondcoat formed onto a surface defined by said cylinder bores, said bondcoat formed by the group consisting of phosphating and anodizing; and
a thermal spray coating deposited on said bondcoat.

21. The component of claim 20, wherein said cylinder bores comprise an aluminum-based material, said bondcoat comprises an oxide of aluminum and said thermal spray coating comprises an oxide of iron.
